(19) United States
(12) Patent Application Publication
(10) Pub. No.: US 2002/0042737 A1
(43) Pub. Date: Apr. 11, 2002

(54) Commodity sales mediation system, commodity sales mediation apparatus, commodity sales mediation method, and recording medium

(76) Inventor: Isao Suetake, Kawasaki (JP)

Correspondence Address: STAAS & HALSEY LLP, 700 11TH STREET, NW, SUITE 500, WASHINGTON, DC, 20001, US

(21) Appl. No.: 09/804,269

(22) Filed: Mar. 13, 2001

(30) Foreign Application Priority Data
Oct. 11, 2000 (JP) 2000-310120

(51) Int. Cl. G06F 17/60

(52) U.S. Cl. 705/14; 705/37

(57) ABSTRACT

In a commodity sales mediation system that permits a wide range of commodity information, which agrees with the liking of a consumer, to be easily presented at a store selling a commodity, when a user carrying a non-contact IC card, in which purchased commodity information and the like are stored, approaches a commodity sales mediation apparatus and reaches the communication range of a non-contact IC card reader/writer, the commodity sales mediation apparatus reads the purchased commodity information and the like stored in the non-contact IC card in a non-contact fashion by a non-contact IC card reader/writer, and an audio output device and a display device output commodity information selected based on the thus read purchased commodity information and the like.

### BACKGROUND OF THE INVENTION

(1) Field of the Invention

The present invention relates to a commodity sales mediation system, a commodity sales mediation apparatus, and a commodity sales mediation method which present commodity information, and to a recording medium capable of being read by a computer and storing a program for causing the computer to execute the respective functions of the above system, apparatus and method. More particularly, the present invention relates to a commodity sales mediation system, a commodity sales mediation apparatus, and a commodity sales mediation method which present commodity information at a store, and to a recording medium capable of being read by a computer and storing a program for causing the computer to execute the respective functions of the above system, apparatus and method.

(2) Description of the Related Art

As a method for consumers to get information as to commodities, there are ordinarily available a method of hearing and observing TV and radio commercials, a method of reading magazine and newspaper advertisements, checking actual commodities at stores. Further, recently, commodity information is frequently presented on home pages of the Internet.

However, the commodity information presented by the TV commercials, the magazine advertisements, has uniform contents aiming at all persons. Thus, the consumers must select the commodity information of a commodity which agrees with the liking of them from the thus presented commodity information, from which a problem is arisen in that it is difficult for the consumers to effectively get the commodity information which they truly desire.

Since the TV commercials, the magazine advertisements and the like present the same commodity information to various persons who have a different liking, there is a problem that the presenters of the commodity information cannot effectively advertise a commodity.

Further, when the consumers intend to get commodity information through the Internet, they must connect the information terminal of a computer to the Internet and sometimes must input the conditions of a commodity which they desire to get. Thus, the consumers have a problem that they cannot easily get desired commodity information.

Furthermore, the commodity information which can be gotten in a store by actually observing commodities is only the information of the commodities displayed in the store. Thus, there is a problem that a wide range of commodity information such as the inventory information of a commodity which is not displayed in the store and the commodity information of a commodity prior to sales cannot be gotten.

### SUMMARY OF THE INVENTION

An object of the present invention, which was made in view of the above problems, is to provide a commodity sales mediation system, a commodity sales mediation apparatus and a commodity sales mediation method capable of presenting a wide range of commodity information that agrees with a liking of consumers.

To achieve the above object, a commodity sales mediation system is provided so as to present commodity information. The commodity sales mediation system for presenting commodity information includes a non-contact information transfer medium in which the purchased commodity information of a commodity purchased by a user is stored, and a commodity sales mediation apparatus including a non-contact information reading unit for reading the purchased commodity information stored in the non-contact information transfer medium in a non-contact fashion when the non-contact information transfer medium reaches a predetermined region and a commodity information output unit for outputting commodity information selected based on the purchased commodity information read by the non-contact information reading means.

To achieve the above object, a commodity sales mediation apparatus is provided so as to present the commodity information. The commodity sales mediation apparatus includes a non-contact information reading unit for reading, when a non-contact information transfer medium in which the purchased commodity information of a commodity purchased by a user is stored, reaches a predetermined region, the purchased commodity information being stored in the non-contact information transfer medium in a non-contact fashion, and a commodity information output unit for outputting commodity information selected based on the purchased commodity information read by the non-contact information reading unit.

To achieve the above object, a commodity sales mediation method is provided so as to present the commodity information. The commodity sales mediation method includes the steps of storing the purchased commodity information of a commodity purchased by a user in a non-contact in transfer medium, reading the purchased commodity information stored in the non-contact information transfer medium when the non-contact information transfer medium reaches a predetermined region, and outputting commodity information selected based on the purchased commodity information having been read.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a construction view showing a construction of a commodity sales mediation system;

FIG. 2 is a construction view showing a construction of a register having a function for providing purchase history information with a non-contact IC card;

FIG. 3 is a construction view showing a construction of a refrigerator having a function for providing commodity database with the non-contact IC card;

FIG. 4 is a construction view showing an overall construction of the commodity sales mediation system;

FIG. 5 is a view exemplifying a construction of personal information stored in the non-contact IC card;

FIG. 6 is a view exemplifying a purchase history table showing purchase history information written to the non-contact IC card;

FIG. 7 is a view exemplifying the entry words of commodity information stored in a maker server;

FIG. 8 is a view exemplifying the entry words of commodity information stored in a maker server;

FIG. 9 is a view exemplifying commodity information displayed on a display device;

FIG. 10 is a flowchart showing procedures for writing purchase history information to the non-contact IC card by the register;

FIG. 11 is a flowchart showing accumulating operation for accumulating commodity data in the refrigerator;

FIG. 12 is a flowchart showing procedures for causing the refrigerator to write purchase history information to the non-contact IC card;

FIG. 13 is a flowchart showing operation for presenting commodity information to a user using a commodity sales mediation apparatus; and

FIG. 14 is a flowchart showing operation for presenting commodity information to the user using the commodity sales mediation apparatus.

### DESCRIPTION OF THE PREFERRED EMBODIMENTS

An embodiment of the present invention will be described below with reference to drawings.

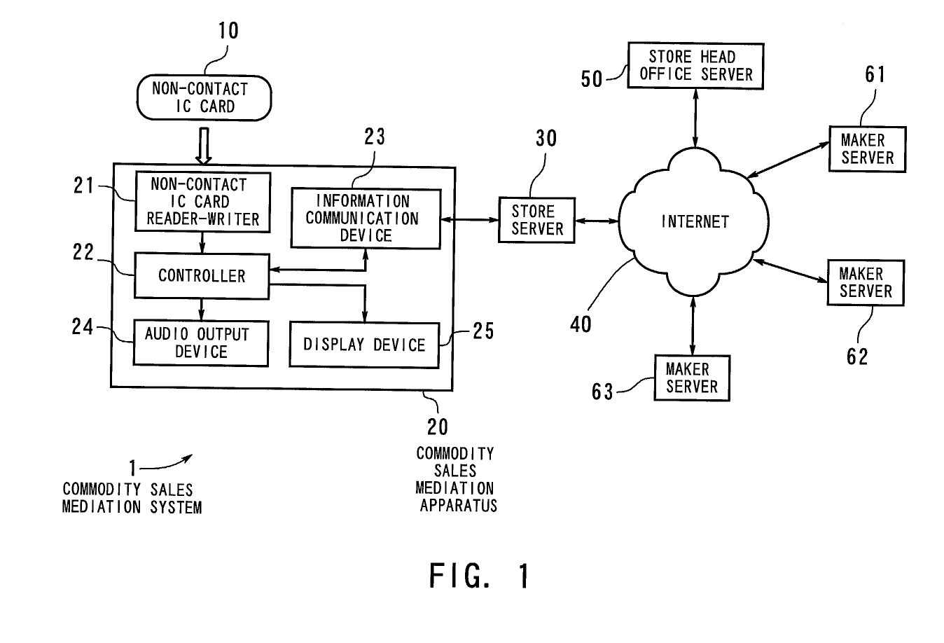

FIG. 1 is a construction view showing a construction of a commodity sales mediation system 1 in the embodiment.

The commodity sales mediation system 1 is mainly composed of a non-contact IC card 10, a commodity sales mediation apparatus 20, a store server 30, the Internet 40, a store head office server 50, and maker servers 61 to 63. The non-contact IC card 10 acts as a non-contact information transmission medium in which the commodity information of a commodity purchased by a user is stored, the commodity sales mediation apparatus 20 presents commodity information, the store server 30 is disposed to a store where the commodity sales mediation apparatus 20 is installed, Internet 40 transmits various kinds of information, the store head office server 50 acts as the head office server of the store where the commodity sales mediation apparatus 20 is installed, and the maker servers 61 to 63 act as the servers of makers of respective commodities.

The commodity sales mediation apparatus 20 is composed of a non-contact IC card reader/writer 21, an information communication device 23, an audio output device 24 and a display device 25, and a controller 22. The non-contact IC card reader/writer 21 acts as a non-contact information reading means for reading purchased commodity information stored in the non-contact information transmission medium in a non-contact fashion when the transmission medium reaches a predetermined region, the information communication device 23 sends and receives various kinds of information through the Internet 40, the audio output device 24 and the display device 25 act as a commodity information output means for outputting the commodity information of a commodity selected based on the purchased commodity information read by the non-contact information reading means, and the controller 22 controls the overall commodity sales mediation apparatus 20.

The non-contact IC card reader/writer 21 is connected to the controller 22, the controller 22 is connected to the information communication device 23, the audio output device 24, and the display device 25, the information communication device 23 is connected to the store server 30, electrically, respectively. The store server 30 is connected to the store head office server 50 and the maker servers 61 to 63 through the Internet 40 so that it can make communication thereto mutually.

Note that the purchased commodity information is image and audio information showing the name and the like of a commodity purchased by the user and includes both purchase history information presented by the register of a store when the user purchases the commodity and commodity database presented from the refrigerator of the user, the details of which will be described later.

The non-contact IC card 10 is composed of a microprocessor for controlling the card, a memory for recording information, a transmitter, a loop antenna for transmitting and receiving information, and performs the delivery of purchased commodity information, and the like in the non-contact fashion.

The commodity information includes such information as new commodity information as to a specific commodity, inventory information, new store open information, store introduction information, recipe information, and presented to respective users in accordance with a liking of them.

The controller 22 is composed of a processor as a main component thereof and operated by a program stored in a ROM (not shown).

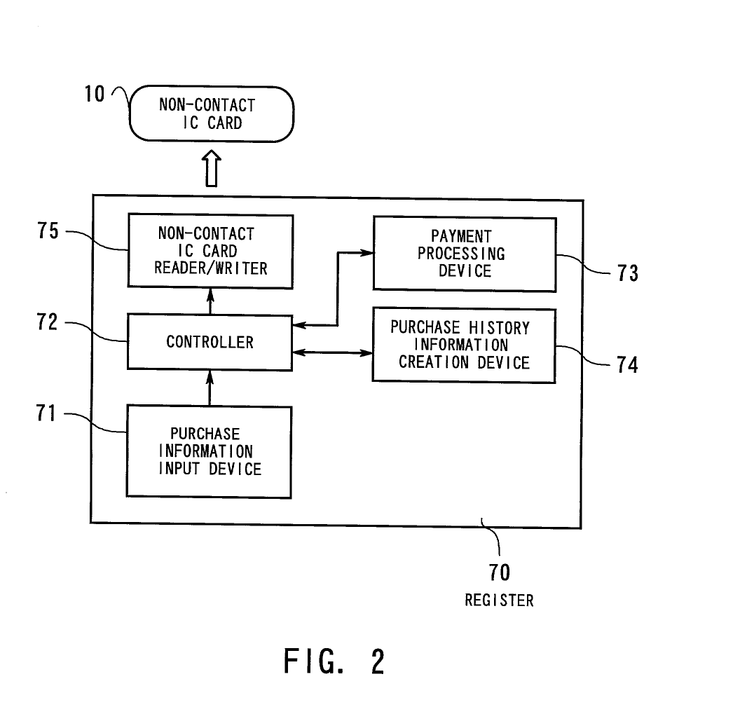

FIG. 2 is a construction view showing a construction of a register 70 having a function for presenting purchase history information to the non-contact IC card 10.

The register 70 is mainly composed of a purchase information input device 71, a payment processing device 73, a purchase history information creation device 74, a controller 72, and a non-contact IC card reader/writer 75. The purchase information input device 71 inputs the information of a purchased commodity, the payment processing device 73 executes payment processing of a purchased commodity, the purchase history information creation device 74 creates the purchase history information, the controller 72 controls the overall register 70, and the non-contact IC card reader/writer 75 writes the created purchase history information to the non-contact IC card 10 in the non-contact fashion.

The purchase information input device 71 is connected to the controller 72, and the controller 72 is connected to the payment processing device 73, the purchase history information creation device 74, and the non-contact IC card reader/writer 75, electrically, respectively.

The purchase information input device 71 is, for example, a reading device for reading information, which is stored in a non-contact tag attached to a commodity to show a price, a type of the commodity , and the like in the non-contact fashion, a bar code reading device for reading a bar code attached to a commodity, a key input device for inputting a type of a commodity and the like through keys. These devices input information of a purchased commodity such as a type and a price of the commodity.

The controller 72 is composed of a processor as a main component thereof and operated by a program stored in a ROM (not shown).

The non-contact IC card reader/writer 75 is composed of a loop antenna, a transmitter, and the like and transmits the purchase history information to the non-contact IC card 10 in the non-contact fashion.

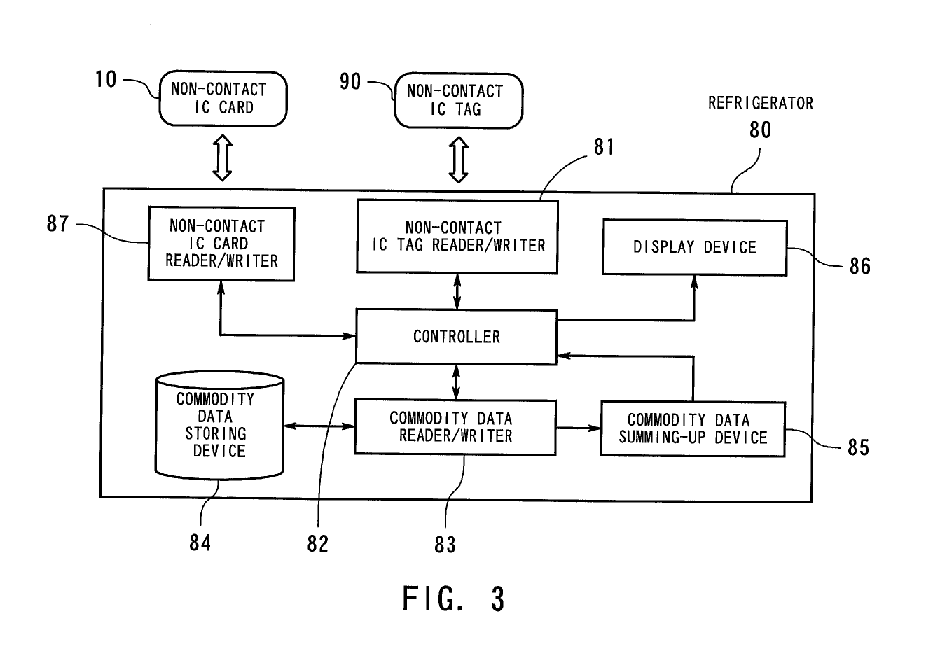

FIG. 3 is a construction view showing a construction of a refrigerator 80 having a function for presenting the commodity database to the non-contact IC card.

The refrigerator 80 mainly includes a non-contact IC tag reader/writer 81, a controller 82, a commodity data storing device 84, a commodity data reader/writer 83, a commodity data summing-up device 85, a display device 86, and a non-contact IC card reader/writer 87. The non-contact IC tag reader/writer 81 reads a non-contact IC tag 90 attached to a food in the non-contact fashion, the controller 82 controls the refrigerator 80, the commodity data storing device 84 stores the commodity data read by the non-contact IC tag reader/writer 81, the commodity data reader/writer 83 reads and writes the commodity data from and to the commodity data storing device 84, the commodity data summing-up device 85 creates commodity database by summing up the commodity data and, the display device 86 displays the commodity data, and the non-contact IC card reader/writer 87 writes the commodity database created by the commodity data summing-up device 85 to the non-contact IC card 10 in the non-contact fashion.

The controller 82 is electrically connected to the non-contact IC tag reader/writer 81, the commodity data reader/writer 83, the commodity data summing-up device 85, the display device 86, and the non-contact IC card reader/writer 87. The commodity data reader/writer 83 is electrically connected to the commodity data storing device 84.

Each of the non-contact IC tag reader/writer 81 and the non-contact IC card reader/writer 87 is composed of a loop antenna, a transmitter, and the like. The non-contact IC card reader/writer 87 reads and writes the commodity database from or to the non-contact IC card 10 in the non-contact fashion, whereas the non-contact IC tag reader/writer 81 reads and writes non-contact IC tag information in the non-contact fashion.

The non-contact IC tag 90 is composed of a microprocessor for controlling the tag, a memory for storing information, a transmitter, a loop antenna and the like and performs the delivery and the like of the non-contact IC tag information in the non-contact fashion. The non-contact IC tag information shows a type and the like of a food to which the non-contact IC tag 90 is attached, and the non-contact IC tag 90 attached to each food stores the non-contact IC tag information.

The controller 82 is composed of a processor as a main component thereof and operated by a program stored in a ROM (not shown).

The commodity data storing device 84 is a storing device such as an IC memory, and a magnetic disc device and stores the commodity data read from the non-contact IC tag 90.

Next, operation of the commodity sales mediation system 1 will be described.

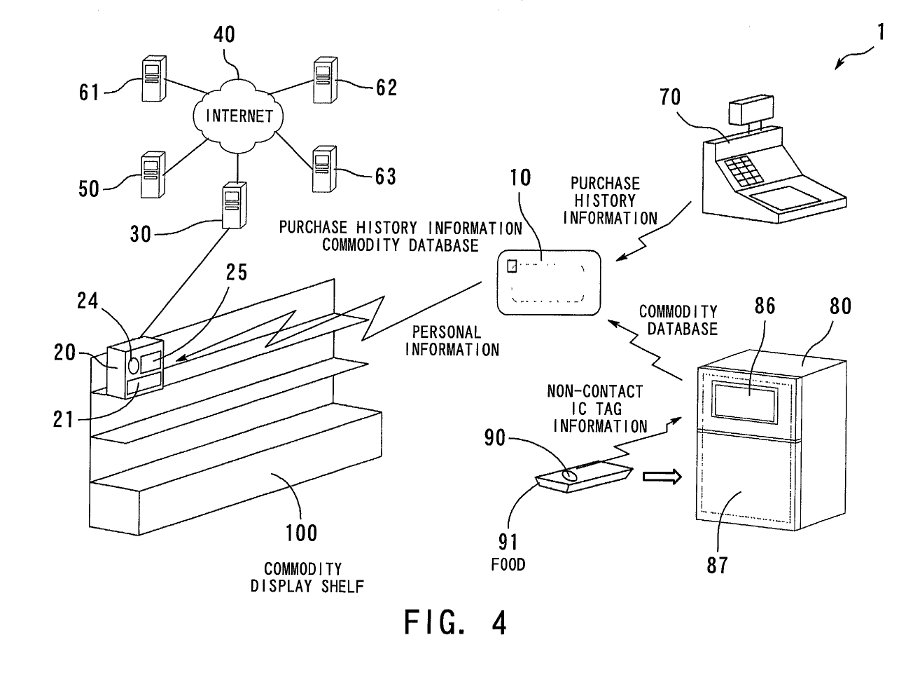

FIG. 4 is a construction view showing an overall construction of the commodity sales mediation system 1.

A user who intends to utilize the commodity sales mediation system 1 first enters into a predetermined utilization contract with a presenter of the system and gets the non-contact IC card 10. The purchased commodity information (purchase history information and commodity database) of a commodity purchased by the user, who has gotten the non-contact IC card 10, at a store is written to the non-contact IC card 10 from the register 70 installed in the store or from the refrigerator 80 of the user in the non-contact fashion. Next, when the user having the non-contact IC card 10 to which the purchased commodity information has been written, approaches a commodity display shelf 100, the purchased commodity information and the like which have been stored in the non-contact IC card 10 is read by the commodity sales mediation apparatus 20 installed in the commodity display shelf 100 by the non-contact fashion. Then, the commodity sales mediation apparatus 20, which has read the purchased commodity information and the like obtains commodity information specified by the purchased commodity information and the like from the store head office server 50 or the maker servers 61 to 63 through the Internet 40 and outputs the thus obtained commodity information through the display device 25 and the audio output device 24.

The above operation will be explained in sequence using FIGS. 1 to 4.

As described above, the user who desires to use the commodity sales mediation system 1 enters the predetermined utilization contract with the presenter of the system. The presenter of this system may be a store where the commodity sales mediation apparatus 20 is installed or an independent presenter which presents this system. When the user enters into the utilization contract, the user presents his or her personal information. The personal information also includes the information of the user such as age, taste, and necessary to specify his or her liking, in addition to the name, address, and phone number.

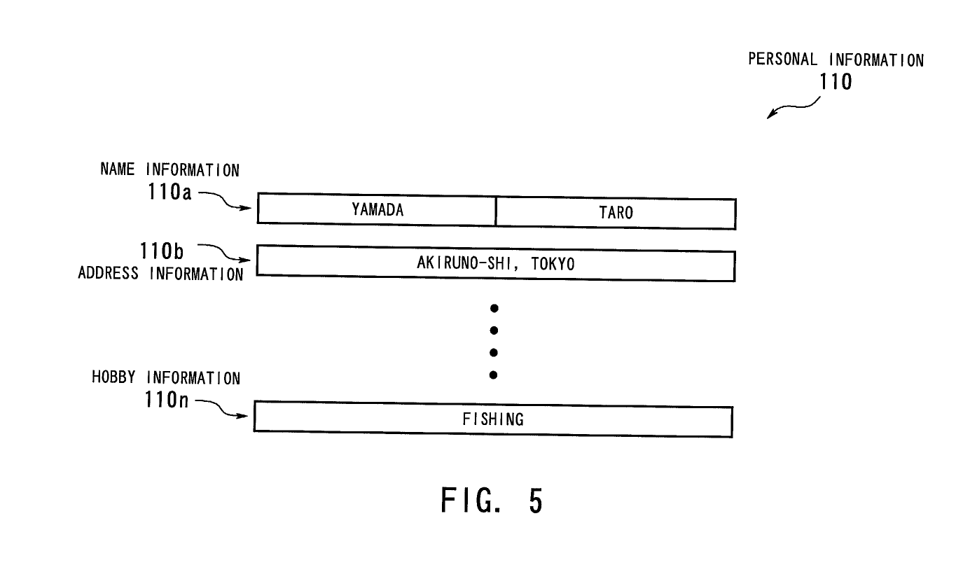

The personal information presented as described above is stored in the non-contact IC card 10 given to the user based on the utilization contact of this system. FIG. 5 is a view exemplifying a construction of the personal information 110 stored in the non-contact IC card 10. As shown in FIG. 5, the personal information 110 is composed of hobby information 11On showing the hobby of the user, in addition to name information 11Oa showing the name of the user, address information 11Ob showing the address of the user and used to select the commodity information presented by the commodity sales mediation apparatus 20.

The purchased commodity information of a commodity purchased by the user, who has gotten the non-contact IC card 10, at a store such as a supermarket is written to the non-contact IC card 10 from the register 70 installed in the store or from the refrigerator 80 of the user in the non-contact fashion.

First, writing operation executed by the register 70 to write the purchase history information will be explained.

The user who intends to purchase a commodity at a store selects the commodity he or she intends to purchase and makes payment to the commodity. The payment processing to the commodity is made by a clerk who inputs a type, a price, and the like of the commodity which the user intends to purchase using the purchase information input device 71 of the register 70 installed in the store. The inputted information is sent to the a payment processing device 73 through the controller 72 to thereby execute the payment processing. Further, the information such as the type of the commodity, which has been inputted is also sent to the purchase history information creation device 74, which creates the purchase history information based on the information sent thereto.

The thus created purchase history information is sent to the non-contact IC card reader/writer 75 through the controller 72, and the non-contact IC card reader/writer 75 writes the purchase history information sent thereto to the non-contact IC card 10 in the non-contact fashion.

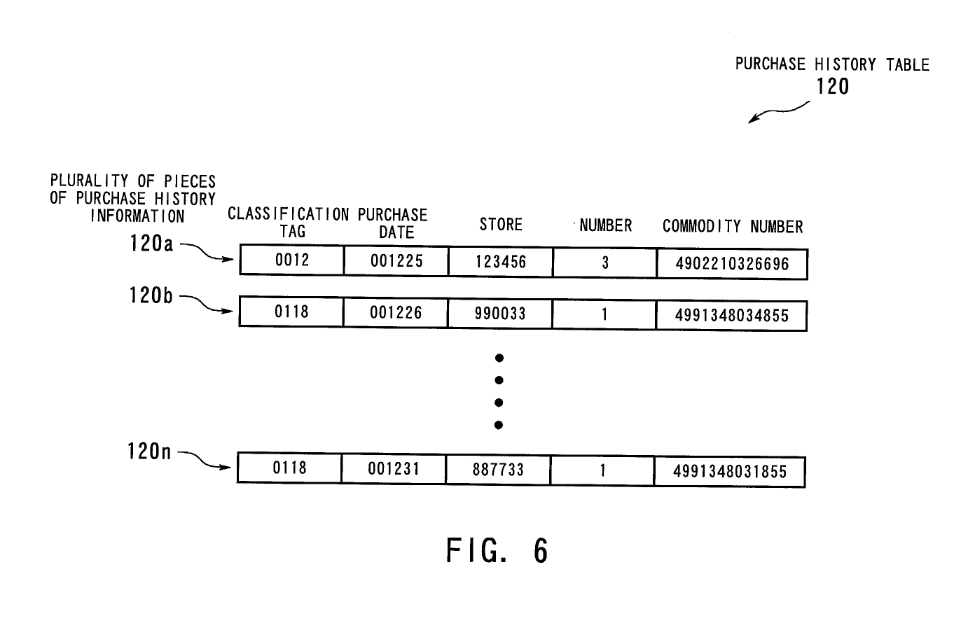

FIG. 6 is a view exemplifying a purchase history table 120 showing the purchase history information written to the non-contact IC card 10 as described above.

The purchase history table 120 is composed a plurality of pieces of purchase history information 120a to 120n each composed of a classification tag showing a field of a commodity, a purchasing date of the commodity, a store at which the commodity was purchased, the purchased number of the commodity, a commodity number showing a type of the purchased commodity.

Next, writing operation executed by the refrigerator 80 to write the purchase history information will be explained.

The refrigerator 80 has a function for automatically detecting a commodity accommodated therein and displaying the information of the accommodated commodity.

When the purchased commodity is a food 91, the user purchased the food 91 accommodates it in the refrigerator 80 installed in a home. The non-contact IC tag 90, in which the non-contact IC tag information such as a type of the food 91 and a purchase date is stored, is attached to the food 91. The non-contact IC tag information is read by the non-contact IC tag reader/writer 81 in the non-contact fashion when the food 91 is accommodated in the refrigerator 80. The non-contact IC tag reader/writer 81 is constructed so as to read the non-contact IC tag information of only the non-contact IC tags 90 disposed in the accommodating space of the refrigerator 80, which permits the commodities accommodated in the refrigerator 80 to be determined. It should be noted that the non-contact IC tag reader/writer 81 may perform the reading operation only when the door of the refrigerator 80 is opened and closed, may perform the operation periodically at predetermined intervals or may perform it continuously.

The non-contact IC tag information read by the non-contact IC tag reader/writer 81 as described above is sent to the commodity data reader/writer 83 through the controller 82. The commodity data reader/writer 83 stores the non-contact IC tag information sent thereto in the commodity data storing device 84 as commodity data. Note that the commodity data may be stored each time when the non-contact IC tag reader/writer 81 reads non-contact IC tag information or may be stored only when the commodities in the refrigerator 80 are replaced. The commodity data stored in the commodity data storing device 84 as described above, is read out by the commodity data reader/writer 83 and sent to the display device 86 through the controller 82, and the display device 86 displays the commodity data sent thereto. The display of the commodity data permits the user to grasp the contents of the foods accommodated in the refrigerator 80.

When the user carrying the non-contact IC card 10 approaches the refrigerator 80 and the non-contact IC card 10 reaches the receiving region of the non-contact IC card reader/writer 87, the IC card reader/writer 87 detects that the non-contact IC card 10 has reached the receiving region and sends a detection signal to the controller 82. The controller 82 received the detection signal causes the commodity data reader/writer 83 to read the commodity data from the commodity data storing device 84 and sends the commodity data read by the commodity data reader/writer 83 to the commodity data summing-up device 85. The commodity data summing-up device 85 sums up the commodity data sent thereto and creates a commodity database. The commodity database created here is data in which the type of the food 91 which was accommodated in the refrigerator 80 in the past, a date when the food 91 was purchased. The commodity database is constituted similarly to the purchase history table 120 shown in FIG. 6.

The thus created commodity database is sent to the non-contact IC card reader/writer 87 through the controller 82, and the non-contact IC card reader/writer 87 writes the commodity database sent thereto to the non-contact IC card 10 in the non-contact fashion.

When the user carrying the non-contact IC card 10 in which the purchase history information and the like have been written by the above processing, visits the store to purchase a commodity and approaches the commodity sales mediation apparatus 20 installed in the commodity display shelf 100 of the store, the commodity sales mediation apparatus 20 outputs commodity information suitable for the purchase history information and the like stored in the non-contact IC card 10. Presenting operation for presenting the commodity information will be explained below.

When the user carrying the non-contact IC card 10 approaches the commodity sales mediation apparatus 20 and the non-contact IC card 10 reaches the receiving region of the non-contact IC card reader/writer 21, the IC card reader/writer 21 reads the purchased commodity information (purchase history information and commodity database) and the personal information stored in the non-contact IC card 10 in the non-contact fashion. The purchased commodity information is read by designating a classification tag showing a type of a commodity, and the type of the commodity selected here is determined in accordance with, for example, a type and the like of a commodity displayed in the commodity display shelf 100 to which the commodity sales promotion apparatus 20 is disposed. The purchased commodity information and the personal information, which are read by the non-contact IC card reader/writer 21, are sent to the information communication device 23 through the controller 22. The information communication device 23 transmits the purchased commodity information and the personal information sent thereto to the store server 30 which determines a server (the store head office server 50 or the maker servers 61 to 63) to which the data is to be transferred from the purchased commodity information and the personal information sent thereto. The determination is made here based on the types of the commodities shown by the purchase history information having been read. For example, when many of the commodities shown by the purchase history information are confectionary, the maker servers 61 to 63 of confectionary makers having new commodity information of confectionary or the store head office server 50 having inventory information of confectionary is selected as a server to which the data is transferred.

When the server to which the data is to be transferred is determined, the store server 30 transmits the purchased commodity information and the personal information to the determined server through the Internet 40.

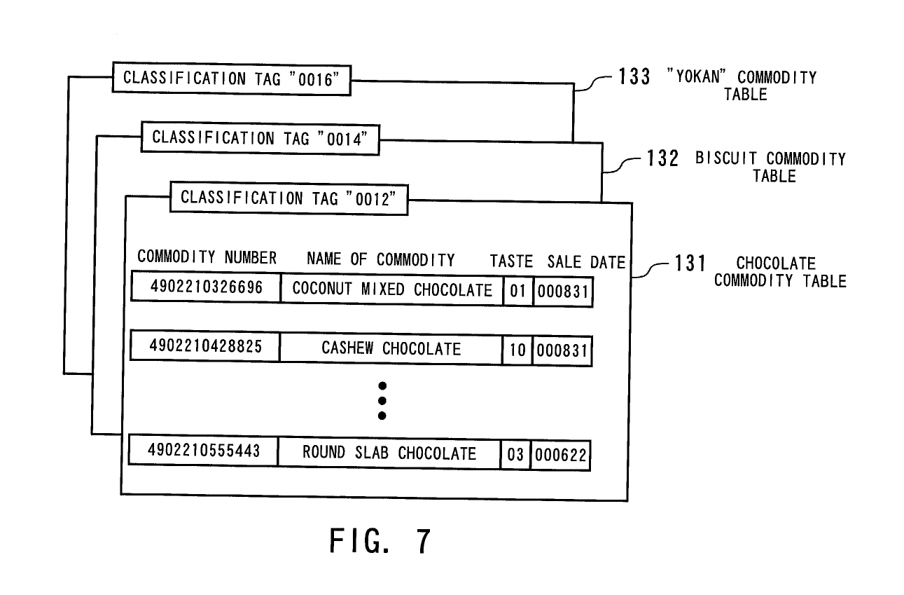

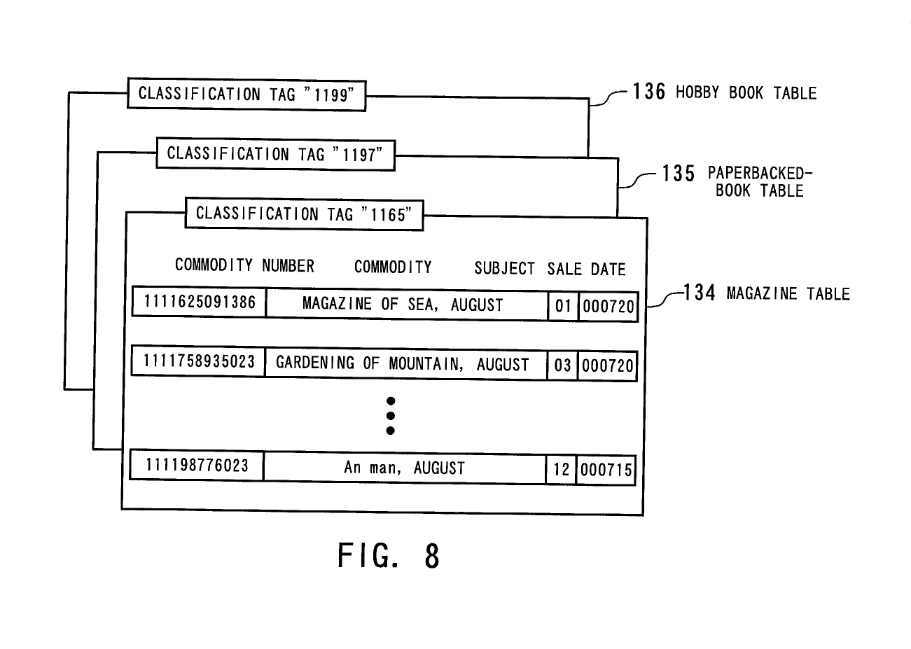

FIGS. 7 and 8 are views exemplifying the entry words of the commodity information stored in the maker servers 61 to 63. FIG. 7 exemplifies entry words of commodity information stored in the server of a confectionary maker, and FIG. 8 exemplifies the entry words of commodity information stored in the server of a publisher. In the examples shown in FIGS. 7 and 8, the respective pieces of the commodity information are classified in respective classification tags; a chocolate commodity table 131, a biscuit commodity table 132, a “yokan” (bar of sweet jellied azuki-bean) commodity table 133, a magazine table 134, a paperbacked-book table 135, and a hobby book table 136, and stored in a unit of each commodity. In FIGS. 7 and 8, a “commodity number” is a number given to each commodity, a “taste” shows a type of a taste of each type of confectionary, and a “subject” shows a subject to be read.

The store head office server 50 or the maker servers 61 to 63 to which the purchased commodity information and the personal information were transmitted determine the taste of a customer by the purchased commodity information and the personal information transmitted thereto and determines commodity information which is to be mediated to the customer. The commodity information to be mediated is determined here by, for example, searching the classification tag and the commodity number of the purchased commodity information transmitted to the store head office server 50 or the maker servers 61 to 63 from the classification tags and the commodity numbers of the commodity information managed thereby or by checking the “taste” and the “subject” of the commodity information against the liking of the user included in the transmitted personal information.

The thus determined commodity information is dressed by being processed in the format of HTML (Hyper Text Markup Language) or the format of CGI (Common Gateway Interface) and then transmitted to the store server 30 through the Internet 40. The commodity information transmitted to the store server 30 is received by the information communication device 23 and then sent to the audio output device 24 and the display device 25 through the controller 22. When the commodity information sent is audio information such as music, the audio output device 24 outputs the commodity information in voice, whereas when the commodity information sent is a picture information such as animation, the display device 25 displays the commodity information using browser software.

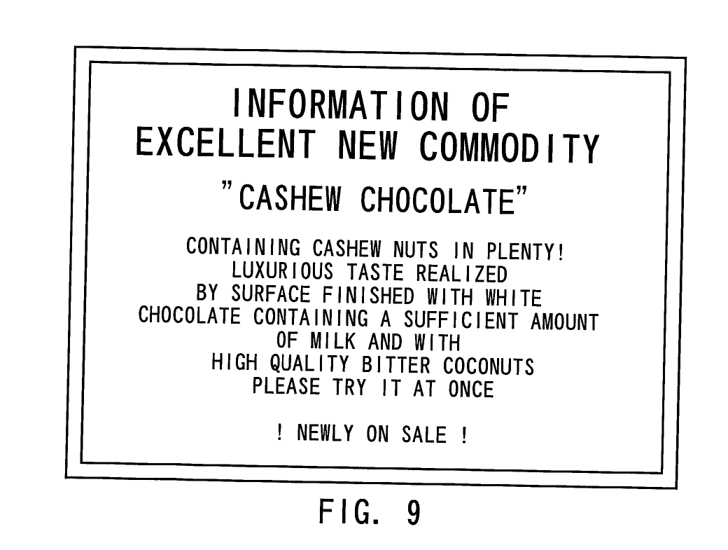

FIG. 9 is a view exemplifying the commodity information displayed on the display device 25 as described above.

The commodity information outputted by the audio output device 24 and the display device 25 is the information which is specified by the purchased commodity information and the personal information stored in the non-contact IC card 10. Therefore, the user can effectively get the commodity information which agrees with his or her liking.

Next, operation of the commodity sales mediation system 1 will be explained using flowcharts.

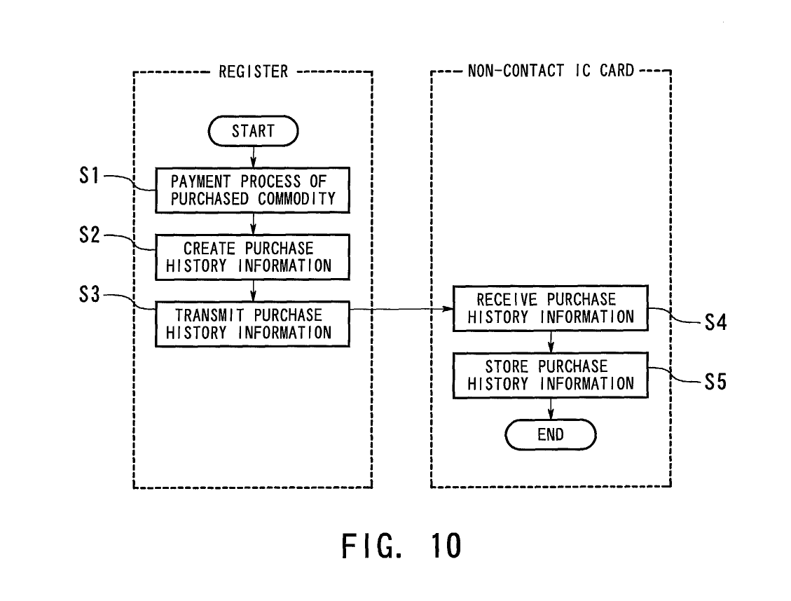

FIG. 10 is a flowchart showing the procedures for writing purchase history information to the non-contact IC card 10 by the register 70.

At step S1, payment processing is executed to a commodity purchased using the purchase information of the commodity inputted by the purchase information input device 71.

At step S2, purchase history information is created using purchase information.

At step S3, the purchase history information created at step S2 is transmitted from the non-contact IC card reader/writer 75 to the non-contact IC card 10.

At step S4, the non-contact IC card 10 receives the purchase history information.

At step S5, the non-contact IC card 10 stores the purchase history information received thereby.

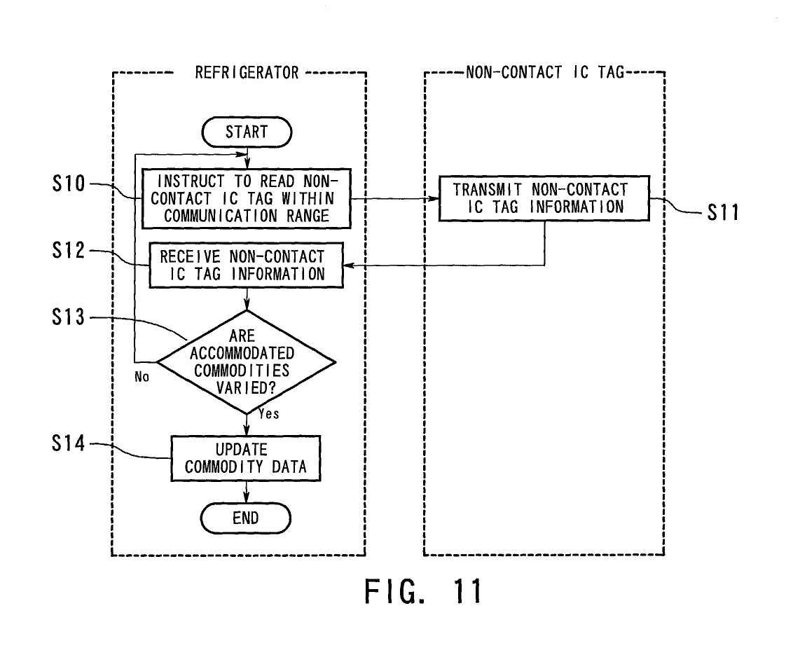

FIG. 11 is a flowchart showing operation for accumulating commodity data in the refrigerator 80.

At step S1O, the non-contact IC tag reader/writer 81 is instructed to read the non-contact IC tag 90 which exists within the communication range thereof.

At step S11, non-contact IC tag information is transmitted from the non-contact IC tag 90 to the non-contact IC tag reader/writer 81.

At step S12, the non-contact IC card 81 receives the non-contact IC tag information.

At step S13, the commodity data reader/writer 83 reads the commodity data stored in the commodity data storing device 84, and it is determined whether or not the commodity, which is shown by the non-contact IC tag information and received at step S12, varies the thus read commodity data. When it is determined that the commodity varies the commodity data, the process goes to step S14. Whereas, when it is determined that the commodity does not vary the commodity data, the process goes to step S10.

At step S14, the the commodity data reader/writer 83 stores the commodity information received at step S12 and shown by the non-contact IC tag information in the commodity data storing device 84 and updates the commodity data stored therein.

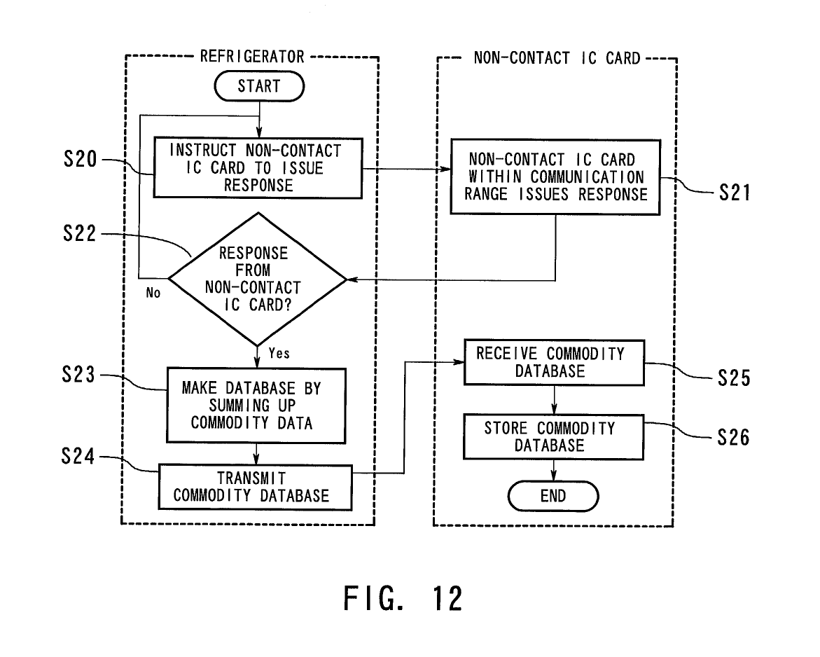

FIG. 12 is a flowchart showing the procedures for writing the purchase history information to the non-contact IC card 10 by the register 80.

At step S20, the non-contact IC card reader/writer 87 instructs the non-contact IC cards 10 to issue a response.

At step S21, a non-contact IC card 10 which exists within the communication range of the non-contact IC card reader/writer 87 issues a response.

At step S22, it is determined whether or not a response has been issued from the non-contact IC cards 10. When the response has been issued, the process goes to step S23, otherwise, the process goes to step S20.

At step S23, the commodity data summing-up device 85 sums up the commodity data stored in the commodity data storing device 84 and creates a commodity database.

At step S24, the non-contact IC card reader/writer 87 transmits the commodity database created at S23.

At step S25, the non-contact IC card 10 receives the commodity database transmitted at step S24.

At step S26, the non-contact IC card 10 stores the commodity database received at step S25.

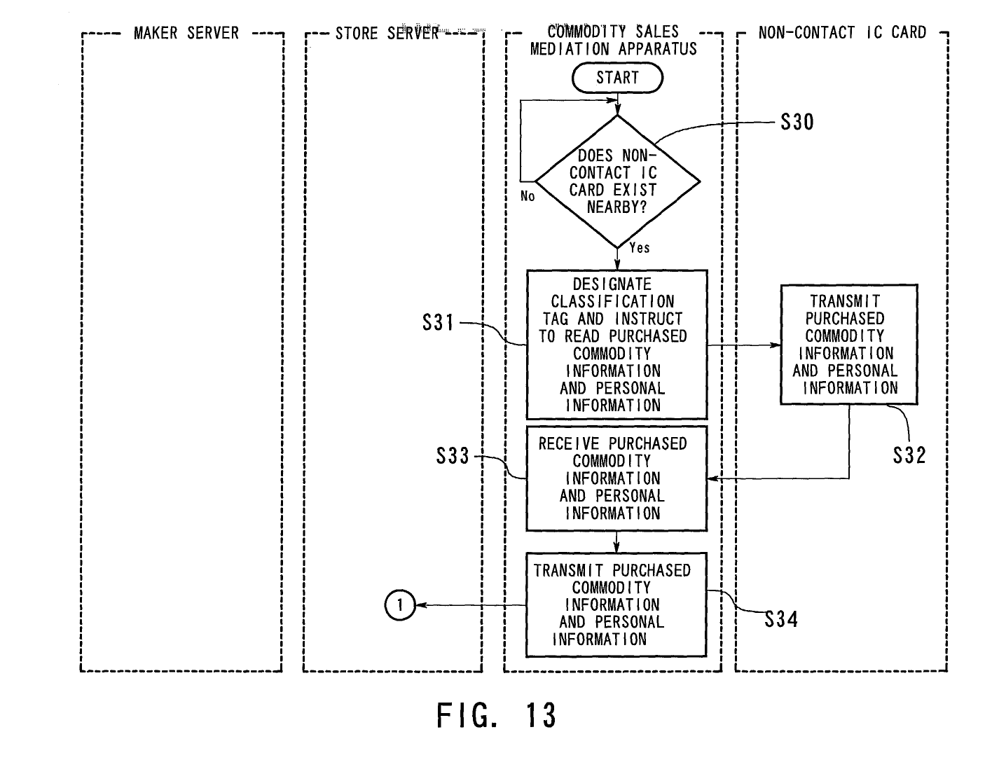

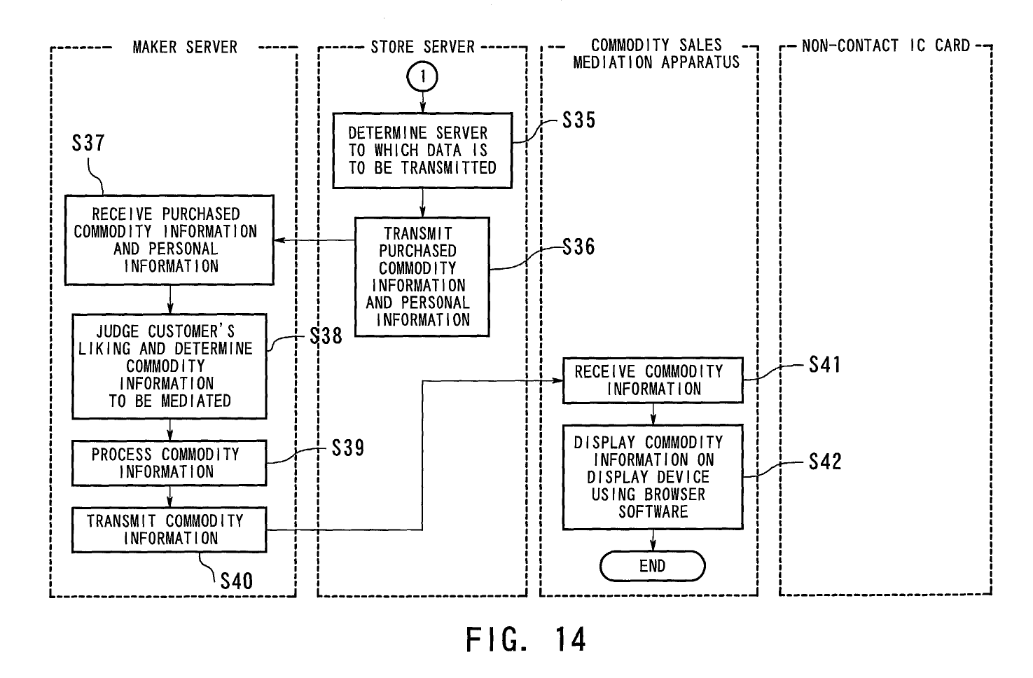

FIGS. 13 and 14 are flowcharts showing operation for presenting commodity information to the user using the commodity sales mediation apparatus 20.

At step S30, it is determined whether or not the non-contact IC card 10 exists within the communication range of the non-contact IC card reader/writer 21. When it exists within the communication range, the process goes to step S31, otherwise, the process stays at step S30.

At step S31, the classification tag of a commodity which is displayed in the commodity display shelf 100 is designated to the non-contact IC card 10 and it is instructed to read out purchased commodity information and personal information.

At step S32, the purchased commodity information and the personal information are transmitted from the non-contact IC card 10 to the non-contact IC card reader/writer 21.

At step S33, the non-contact IC card reader/writer 21 receives the purchased commodity information and the personal information received at step S32.

At step S34, the purchased commodity information and the personal information received at step S33 are transmitted to the store server 30.

At step S35, a server to which the data of the purchased commodity information and the personal information having been transmitted is to be transmitted is determined.

At step S36, the purchased commodity information and the personal information are transmitted to the server determined at step S35.

At step S37, the maker servers 61 to 63 acting as the servers to which the data is to be transmitted receives the purchased commodity information and the personal information transmitted at step S36.

At step S38, the maker servers 61 to 63 judge the liking of a customer based on the purchased commodity information and the personal information transmitted thereto and determines commodity information to be mediated.

At step S39, the commodity information determined at step S38 is processed.

At step S40, the commodity information processed at step S39 is transmitted to the commodity sales mediation apparatus 20.

At step S41, the commodity sales mediation apparatus 20 receives the commodity information transmitted at step S40.

At step S42, the display device 25 displays the commodity information received at step S41 making use of browser software.

As described above, in the embodiment, the user carrying the non-contact IC card 10, in which the purchased commodity information and the like are stored, approaches the commodity sales mediation apparatus 20 and reaches the communication range of the non-contact IC card reader/writer 21, the commodity sales mediation apparatus 20 reads the purchased commodity information and the like stored in the non-contact IC card 10 by the non-contact IC card reader/writer 21 in the non-contact fashion, and the audio output device 24 and the display device 25 output commodity information selected based on the thus read purchased commodity information and the like. Therefore, commodity information which agrees with the liking of a consumer can be effectively presented.

Further, the commodity information to be selected is information which is widely collected from the store head office server 50 and the maker servers 61 to 63 which are connected through the Internet 40 based on the thus read purchased commodity information and the like, which permits the consumer to get a wide rage of commodity information according to his or her liking.

Further, since the purchased commodity information is read and written from and to the non-contact IC card 10 in the non-contact fashion, the user can easily get the commodity information according to his or her liking only by approaching the commodity sales mediation apparatus 20 without executing special input operation.

Note that the above processing functions can be realized by a computer. In that case, the contents of processing to be executed by the function of the commodity sales mediation apparatus 20 are described in a program recorded in a recording medium which can be read by the computer. Then, the execution of the program by the computer permits the above processing to be realized by the computer. A magnetic recording device, and a semiconductor device are exemplified as the recording medium that can be read by the computer. The program can be put on the market by being stored in a portable recording medium such as a compact disc read only memory (CD-ROM), a floppy disc or can be transferred to other computer through a network by being stored in a memory device of a computer connected through the network. When the program is executed by computer, it is stored in a hard disc device in the computer and executed by being loaded to a main memory.

Further, while the non-contact IC card 10 is used as the non-contact information transfer medium in the embodiment, other communication device may be used as the non-contact information transfer medium so long as it can read and write information in the non-contact fashion.

Further, while the personal information of a user is stored in the non-contact IC card 10 and utilized to select commodity information in the embodiment, the personal information may not be utilized for the selection of the commodity information regardless of that the personal information is stored in the non-contact IC card 10 or not.

While both the non-contact IC tag reader/writer 81 and the non-contact IC card reader/writer 87 are provided with the refrigerator 80, they may be constructed as a common component.

Further, while the commodity sales mediation apparatus 20 is connected to the Internet 40 through the store server 30 in the embodiment, it may be directly connected to the Internet 40 without passing through the store server 30.

While the each server transfers information through the Internet in the embodiment, the information may be transferred through other electric communication means such as an Intranet and LAN.

Further, a recording device such as a hard disc may be provided with the commodity sales mediation apparatus 20 to store commodity information, and commodity information may be selected from the recording device and output without using the electric communication means such as the Internet.

Furthermore, an information input means such as input keys and a touch panel may be provided with the commodity sales mediation apparatus 20 so that the user can select commodity information which he or she desires to check visually or auditorily.

As described above, according to the present invention, when a user carrying the non-contact information transfer medium in which purchased commodity information is stored approaches the commodity sales mediation apparatus and reaches the predetermined region, the non-contact information reading means reads the purchased commodity information stored in the non-contact information transfer medium in the non-contact fashion, and the commodity information output means outputs the commodity information selected based on the thus read purchased commodity information. Therefore, it is possible to easily present a wide range of commodity information which agrees with the liking of a consumer.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A commodity sales mediation system for presenting commodity information, comprising:
a non-contact information transfer medium in which the purchased commodity information of a commodity purchased by a user is stored; and
a commodity sales mediation apparatus comprising non-contact information reading means for reading the purchased commodity information stored in said non-contact information transfer medium in a non-contact fashion when said non-contact information transfer medium reaches a predetermined region and commodity information output means for outputting commodity information selected based on the purchased commodity information read by said non-contact information reading means.

2. A commodity sales mediation system according to claim 1, wherein said commodity information output means outputs the presented commodity information through electric communication means.

3. A commodity sales mediation system according to claim 1, wherein the purchased commodity information is information written to said non-contact information transfer medium in the non-contact fashion.

4. A commodity sales mediation apparatus for presenting commodity information, comprising:
non-contact information reading means for reading, when a non-contact information transfer medium in which the purchased commodity information of a commodity purchased by a user is stored, reaches a predetermined region, the purchased commodity information being stored in said non-contact information transfer medium in a non-contact fashion; and
commodity information output means for outputting commodity information selected based on the purchased commodity information read by said non-contact information reading means.

5. A commodity sales mediation apparatus according to claim 4, wherein said commodity information output means outputs the presented commodity information through electric communication means.

6. A commodity sales mediation method for presenting commodity information, comprising the steps of:
storing the purchased commodity information of a commodity purchased by a user in a non-contact in transfer medium;
reading the purchased commodity information stored in said non-contact information transfer medium when said non-contact information transfer medium reaches a predetermined region; and
outputting commodity information selected based on the purchased commodity information having been read.

7. A commodity sales mediation method according to claim 6, wherein the commodity information is information presented through electric communication means.

8. A recording medium capable of being read by a computer, wherein the recording medium stores a program for causing the computer to execute a function for reading, when a non-contact information transfer medium in which the purchased commodity information of a commodity purchased by a user is stored, reaches a predetermined region, the purchased commodity information stored in said non-contact information transfer medium in a non-contact fashion and outputting commodity information selected based on the purchased commodity information having been read.

9. A recording medium according to claim 8, wherein the commodity information is information presented through electric communication means.
